(19) United States
(12) Patent Application Publication
(10) Pub. No.: US 2026/0160873 A1
(43) Pub. Date: Jun. 11, 2026

(54) OUTLIER DETECTION FOR VEHICLE MOTION ESTIMATION

(71) Applicant: VOLVO TRUCK CORPORATION, Göteborg (SE)

(72) Inventors: Murat KUMRU, Göteborg (SE); Mats RYDSTRÖM, Billdal (SE); Mats JONASSON, Partille (SE)

(73) Assignee: VOLVO TRUCK CORPORATION, Göteborg (SE)

(21) Appl. No.: 19/380,099

(22) Filed: Nov. 5, 2025

(30) Foreign Application Priority Data
Dec. 6, 2024 (EP) 24218129.5

(51) Int. Cl. G01S 13/00; G01P 3/44; G01P 21/02; G01S 7/40; G01S 13/58

(52) U.S. Cl. CPC G01S 13/006; G01P 3/44; G01P 21/02; G01S 7/40; G01S 13/589

(57) ABSTRACT

A system for determining the presence of one or more outliers in the plurality of measurements from a vehicle motion estimation system has radar sensors to obtain measurements relating to one or more first unknown motion parameters of a vehicle; one or more inertial sensors to obtain measurements relating to one or more second unknown motion parameters of the vehicle, wherein the total number of sensors is at least one more than the total number of unknown motion parameters; and processing circuitry to: acquire a measurement of each of the first unknown motion parameters from the one or more radar sensors; acquire a measurement of each of the second unknown motion parameters from the one or more inertial sensors; determine an estimated value for each of the first and second unknown motion parameters based on the received measurements; determine a residual between the estimated values and the received measurements; and determine the presence of one or more outliers in the plurality of measurements if the determined residual fails to meet an acceptance criterion.

### TECHNICAL FIELD

The disclosure relates generally to vehicle control. In particular aspects, the disclosure relates to outlier detection for vehicle motion estimation. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In many vehicle operations, precise control of vehicle movement is required or at least beneficial. Such control is often based on estimates of the current motion states of the vehicle. Various approaches to vehicle motion estimation have been proposed. Some of these approaches involve sensors such as radar sensors and inertial sensors that detect various motion parameters of a vehicle. Accurate and reliable estimation or measurement of motion parameters is important for vehicle motion management, in particular to control the vehicle in a safe an efficient manner.

However, estimating motion parameters can be challenging. Any real-world motion estimation system can be susceptible to hardware and software failures, for example due to challenging or inappropriate operating conditions. Radar-based motion estimation is no exception, and can have specific issues relating to, for example, observation of dynamic objects in the surrounding environment, sensor failure, sensor movement, obstruction of the sensor field of view (e.g. due to environmental factors such as precipitation, mud, and dust), and the like.

It is therefore desired to provide systems, methods and other approaches for vehicle motion estimation that attempt to resolve or at least mitigate one or more of these issues.

### SUMMARY

This disclosure provides systems, methods and other approaches for determining the presence of one or more outliers in a plurality of measurements made by a motion estimation system of a vehicle. In particular, measurements made by a number of radar and inertial sensors can be analysed to determine if any of the sensors is outputting incorrect, or otherwise irrelevant or uninteresting, measurements. Furthermore, the specific sensor(s) that is producing the outlier(s) can be identified. In this way, more accurate estimations of vehicle motion can be determined by excluding outlier measurements, and it can be indicated to an operator that maintenance of the sensor(s) is required.

According to a first aspect of the disclosure, there is provided a system comprising: one or more radar sensors configured to obtain measurements relating to one or more first unknown motion parameters of a vehicle; one or more inertial sensors configured to obtain measurements relating to one or more second unknown motion parameters of the vehicle, wherein the total number of sensors is at least one more than the total number of unknown motion parameters; and processing circuitry configured to: acquire a measurement of each of the first unknown motion parameters from the one or more radar sensors; acquire a measurement of each of the second unknown motion parameters from the one or more inertial sensors; determine an estimated value for each of the first and second unknown motion parameters based on the received measurements; determine a residual between the estimated values and the received measurements; and determine the presence of one or more outliers in the plurality of measurements if the determined residual fails to meet an acceptance criterion.

The first aspect of the disclosure may seek to provide a system capable of determining (or detecting) the presence of incorrect, or otherwise irrelevant or uninteresting, measurements made by a motion estimation system of a vehicle. A technical benefit may include that measurements made by a number of radar and inertial sensors can be analysed to determine if any of the sensors is outputting incorrect measurements. Furthermore, the specific sensor(s) that is producing the outlier(s) can be identified. In this way, more accurate estimations of vehicle motion can be determined by excluding outlier measurements, and it can be indicated to an operator that maintenance of the sensor(s) is required.

Optionally in some examples, including in at least one preferred example, the one or more radar sensors comprise one or more ground speed radar sensors. A technical benefit may include that the presence of incorrect, irrelevant, or uninteresting measurements made by ground speed radar sensors of a motion estimation system can be determined.

Optionally in some examples, including in at least one preferred example, the first unknown motion parameters comprise one or more of a longitudinal velocity of the vehicle, a lateral velocity of the vehicle, a vertical velocity of the vehicle, a yaw rate of the vehicle, a roll rate of the vehicle, and a pitch rate of the vehicle. A technical benefit may include that the presence of incorrect, irrelevant, or uninteresting measurements of a number of different motion parameters of the vehicle made by a one or more radar sensors can be determined.

Optionally in some examples, including in at least one preferred example, the second unknown motion parameters comprise one or more of a yaw rate of the vehicle, a roll rate of the vehicle, and a pitch rate of the vehicle. A technical benefit may include that the presence of incorrect, irrelevant, or uninteresting measurements of a number of different motion parameters of the vehicle made by a one or more inertial sensors can be determined.

Optionally in some examples, including in at least one preferred example, the processing circuitry is configured to acquire a measurement from each of the sensors. A technical benefit may include that all data sources in the motion estimation system can be used, enabling overdetermination of the system and the identification of any inconsistency in measurements.

Optionally in some examples, including in at least one preferred example, the received measurements are obtained by the sensors at a same time instant. A technical benefit may include that, by taking measurements simultaneously, it is ensured that the motion parameters measured by the sensors relate to the same behaviour of the vehicle and can be readily compared to identify any inconsistency.

Optionally in some examples, including in at least one preferred example, the processing circuitry is configured to determine an estimated value for each of the one or more unknown motion parameters using a pseudo inverse of a measurement matrix. A technical benefit may include that an accurate estimate of the state of the vehicle can be provided by inverting a measurement process that may not be directly invertible due to noise, redundancy, or incomplete information.

Optionally in some examples, including in at least one preferred example, each subset of a measurement matrix has full column rank, wherein each subset omits one of the received measurements. A technical benefit may include that a unique and/or proper solution of the associated linear system can be determined as the system is overdetermined and there is a redundant source of information for each measurement.

Optionally in some examples, including in at least one preferred example, the system comprises three or more sensors, and the processing circuitry is configured to: receive a measurement from each of the three or more sensors, wherein the total number of sensors is at least two more than the total number of unknown motion parameters; determine a plurality of subsets of the received measurements, wherein each subset omits one of the received measurements; determine an estimated value for each of the first and second unknown motion parameters for each determined subset of the received measurements; determine a residual between the respective estimated values and each determined subset of the received measurements; and identify one or more outliers in the plurality of measurements based on the determined residuals. A technical benefit may include that the specific sensor(s) that is producing the outlier(s) can be identified, enabling more accurate estimations of vehicle motion to be determined and for appropriate action, e.g. maintenance of the sensor(s), to be performed.

Optionally in some examples, including in at least one preferred example, the processing circuitry is further configured to provide one or more of information relating to the one or more identified outliers and an estimate of vehicle motion via a user interface for an operator of the vehicle. A technical benefit may include that the erroneous measurements can be taken into account when controlling the vehicle, e.g. via a driver input, and appropriate action, e.g. maintenance of the sensor(s), can be performed.

Optionally in some examples, including in at least one preferred example, the processing circuitry is further configured to cause an action by a motion management system of the vehicle in response to determining the presence of one or more outliers. A technical benefit may include that an initial motion estimate can be discounted when controlling the vehicle, and vehicle motion can be estimated based on other inputs.

According to a second aspect of the disclosure, there is provided a vehicle comprising the system of the first aspect. The second aspect of the disclosure may seek to provide a vehicle capable of determining the presence of incorrect, irrelevant, or uninteresting measurements made by a motion estimation system of the vehicle, in particular measurements made by a number of radar and inertial sensors.

According to a third aspect of the disclosure, there is provided a computer-implemented method comprising: acquiring, by processing circuitry of a computer system, a measurement of each of one or more first unknown motion parameters of a vehicle based on one or more radar sensors; acquiring, by the processing circuitry, a measurement of each of one or more second unknown motion parameters of the vehicle based on one or more inertial sensors, wherein the total number of sensors is at least one more than the total number of unknown motion parameters; determining, by the processing circuitry, an estimated value for each of the first and second unknown motion parameters based on the received measurements; determining, by the processing circuitry, a residual between the estimated values and the received measurements; and determining, by the processing circuitry, the presence of one or more outliers in the plurality of measurements if the determined residual fails to meet an acceptance criterion.

The third aspect of the disclosure may seek to provide a method capable of determining (or detecting) the presence of incorrect, or otherwise irrelevant or uninteresting, measurements made by a motion estimation system of a vehicle. A technical benefit may include that measurements made by a number of radar and inertial sensors can be analysed to determine if any of the sensors is outputting incorrect measurements. Furthermore, the specific sensor(s) that is producing the outlier(s) can be identified. In this way, more accurate estimations of vehicle motion can be determined by excluding outlier measurements, and it can be indicated to an operator that maintenance of the sensor(s) is required.

According to a fourth aspect of the disclosure, there is provided a computer program product comprising program code for performing, when executed by processing circuitry, the computer-implemented method of the third aspect. The fourth aspect of the disclosure may seek to enable new vehicles and/or legacy vehicles to be conveniently configured, by software installation/update, to determine the presence of incorrect, irrelevant, or uninteresting measurements made by a motion estimation system of the vehicle, in particular measurements made by a number of radar and inertial sensors.

According to a fifth aspect of the disclosure, there is provided a non-transitory computer-readable storage medium comprising instructions, which when executed by processing circuitry, cause the processing circuitry to perform the computer-implemented method of the third aspect. The fifth aspect of the disclosure may seek to enable new vehicles and/or legacy vehicles to be conveniently configured, by software installation/update to determine the presence of incorrect, irrelevant, or uninteresting measurements made by a motion estimation system of the vehicle, in particular measurements made by a number of radar and inertial sensors.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a side view of a vehicle according to an example of the disclosure.

FIG. 2 schematically shows a top view of a vehicle comprising a motion estimation system according to an example of the disclosure.

FIGS. 3A and 3B geometrically illustrate linear systems comprising a number of state variables and measurements.

FIG. 4 is a flow chart of a computer-implemented method according to an example of the disclosure.

FIG. 5 illustrates the results of testing of a vehicle motion estimation system.

FIG. 6 illustrates motion estimates obtained without any outlier identification mechanism.

FIG. 7 illustrates motion estimates obtained by excluding the identified outliers.

FIG. 8 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

In many vehicle operations, precise control of vehicle movement is required. Such control is often based on estimates of the current motion states of the vehicle. Accurate and reliable estimation or measurement of motion parameters is important for vehicle motion management, in particular to control the vehicle in a safe an efficient manner. However, estimating motion parameters can be challenging. Any real-world motion estimation system can be susceptible to hardware and software failures, for example due to challenging or inappropriate operating conditions. Radar-based motion estimation is no exception, and can have specific issues relating to, for example, observation of dynamic objects in the surrounding environment, sensor failure, sensor movement, obstruction of the sensor field of view (e.g. due to environmental factors such as precipitation, mud, and dust), and the like.

To remedy this, systems, methods and other approaches are provided for determining (or detecting) the presence of one or more outliers in a plurality of measurements made by a motion estimation system of a vehicle. In particular, measurements made by a number of radar and inertial sensors can be analysed to determine if any of the sensors is outputting incorrect, or otherwise irrelevant or uninteresting, measurements. Furthermore, the specific sensor(s) that is producing the outlier(s) can be identified. In this way, more accurate estimations of vehicle motion can be determined by excluding outlier measurements, and it can be indicated to an operator that maintenance of the sensor(s) is required.

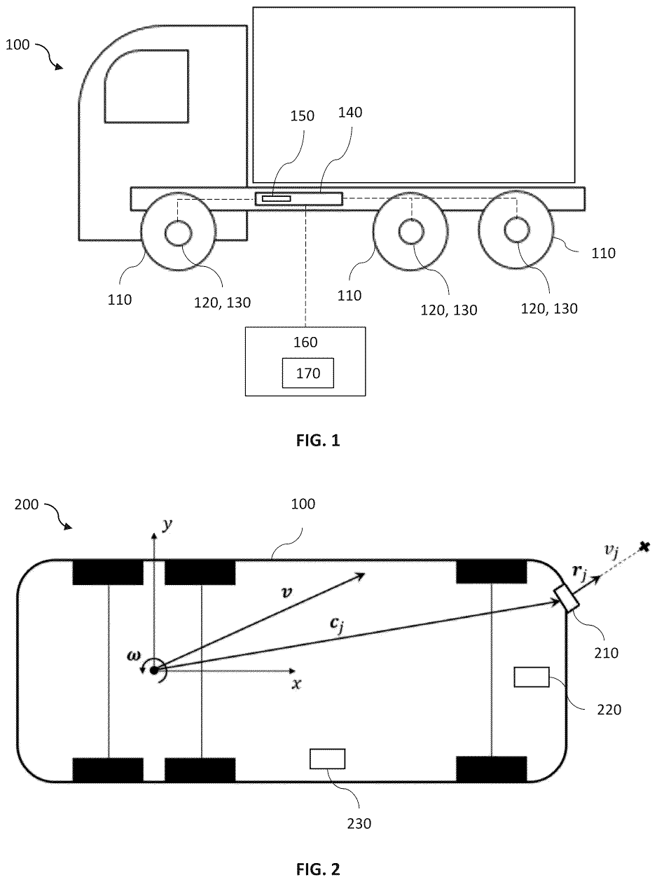

FIG. 1 schematically shows a side view of an example vehicle 100 of the type considered in this disclosure. The vehicle 100 may be any suitable form of vehicle. For example, the disclosure can be applied in heavy-duty vehicles, such as trucks, buses, construction equipment, and multi-unit vehicle combinations, in personal vehicles such as cars, vans, or motorbikes, or in any other suitable form of vehicle. The vehicle 100 comprises a number of axles, each generally having two or more wheels 110. Each wheel is provided with a tyre. Whilst three axles are shown, it will be appreciated that any suitable number of axles may be provided. It will also be appreciated that any number of the axles may be driven axles. The vehicle 100 normally comprises a steered axle, or more than one steered axle.

The vehicle 100 may comprise one or more sources of propulsion. For example, the vehicle 100 may comprise one or more electrical machines 120 such as electric motors and/or generators. The vehicle 100 may comprise one or more batteries (not shown) configured to provide power to the electrical machines 120. In some examples, the vehicle 100 may also include another source of propulsion, for example an internal combustion engine (ICE). The vehicle 100 also comprises a drivetrain (not shown) to deliver mechanical power from the propulsion source (the electrical machines 120 or the ICE) to the wheels 110. The vehicle 100 may be driven solely by ICE, solely by electric machines, or by a combination of electric and combustion engine-based motors.

The electrical machines 120 are configured to drive, e.g. provide torque and/or steering to, one or more axles or individual wheels 110 of the vehicle 100. The electrical machines 120 can supply either a positive (propulsion) or negative (braking) force. The use of electrical machines 120 to supply a negative force is known as regenerative braking, in which case the electrical machines 120 may be operated as generators, in order to recover energy during braking.

Furthermore, the vehicle 100 may comprise one or more sets of service brakes 130. The service brakes 130 can supply a negative (braking) force. The service brakes 130 may be, for example, frictional brakes such as pneumatic brakes. Pneumatic brakes use a compressor to fill the brake with air, which may be powered by the batteries. In some examples, the brakes may be electro-mechanical brakes. The energy recovered from regenerative braking by the electrical machines 120 can be stored in the batteries, and so regenerative braking may generally be preferred over the use of service brakes. The electrical machines 120, service brakes 130, and ICE of a vehicle 100 may be referred to as actuators or motion support devices (MSDs) of the vehicle 100.

In some examples, the vehicle 100 may be a vehicle combination comprising a number of units, including a tractor unit and at least one trailing unit. A tractor unit is generally the foremost unit in a vehicle combination, and may comprise the cabin for the driver, including steering controls, dashboard displays and the like. Generally, the tractor unit is used to provide propulsion power for the vehicle combination 100. A trailing unit is generally used to store goods that are being transported by the vehicle combination 100. A trailing unit may be a truck, trailer, dolly and the like. A trailing unit may also provide propulsion to the vehicle combination 100. In such examples, each unit may comprise its own electrical machines 120, batteries, service brakes 130, and the like. In this way, all units may provide propulsion to the vehicle combination 100.

The vehicle 100 may include a controller 140 comprising processing circuitry 150. The controller 140 is configured to control components of the vehicle, for example the electrical machines 120. FIG. 1 shows a common controller 140 for all electrical machines 120 of the vehicle 100, however it will be appreciated that each electrical machine 120 may have its own respective controller 140. In many cases, the controller 140 may be implemented in the structure of the electrical machine 120 itself. The controller 140 may be a microcontroller. In examples where the vehicle 100 is a vehicle combination, the vehicle 100 may include a global controller and a plurality of unit controllers, for example a controller for each unit. Vehicle motion management may therefore be available on a unit level to receive requests from a manual or virtual driver to coordinate the propulsion, braking and steering.

The controller 140 (or its processing circuitry 150) may receive control signals from a global controller 160 comprising processing circuitry 170. The global controller 160 may be a vehicle control unit configured to perform various vehicle (unit) control functions, such as vehicle motion management. The global controller 160 may be local to the vehicle 100, for example implemented as part of the controller 140, or may be a remote system, implemented at a distance from the vehicle 100. The global controller 160 may be communicatively coupled to the controller 140 in any suitable way, for example via a circuit or any other wired, wireless, or network connection known in the art. Furthermore, the communicative coupling may be implemented as a direct connection between the controller 140 and the global controller 160, or may be implemented as a connection via one or more intermediate entities.

One function of the controller 140 and the global controller 160 is to provide control inputs for the vehicle 100, for example torque, force, or slip requests. These control inputs may be determined based on an estimation of vehicle motion provided by a vehicle motion estimation system. It is therefore important that the output of such a motion estimation system is reliable to enable the resulting control inputs to be accurate and safe.

FIG. 2 schematically shows a motion estimation system 200 for a vehicle, such as the vehicle 100. The motion estimation system 300 comprises a number of data sources, including one or more radar sensors 210 and one or more inertial sensors 220, as well as processing circuitry 230 (compare with 150 and 170 of FIG. 1). The vehicle motion is represented in a coordinate system where the x-direction is a longitudinal direction of motion and the y-direction is a lateral direction of motion of the vehicle 100. The translational and the rotational velocity vectors of the vehicle 100 with respect to the ground are represented by v≙[vₓ v_{y}]^{T} and ω?[0 0 ω_{z}]^{T}, respectively. Whilst the motion estimation system 200 is represented in two dimensions, it will be appreciated that the system 200 may also operate in three dimensions.

The radar sensor 210 comprises a radar antenna and/or transceiver configured to receive and/or transmit radio waves. In particular, a radar sensor 210 emits a radar beam outward towards a radar target X and receives radar backscatter in the form of reflected radio waves from the target X. The radar sensor(s) 210 may be configured to emit a radar beam in any suitable direction. The position of the j^{th} radar in the vehicle coordinate frame is denoted by

$${c}_{j} {=}^{Δ} {[ {c}_{j}^{x} {c}_{j}^{y} ]}^{T}$$

relative to a suitable reference point. The corresponding unit-length observation vector is indicated by

$${r}_{j} {=}^{Δ} {[ {r}_{j}^{x} {r}_{j}^{y} ]}^{T} ,$$

and is dependent on the transmission properties and orientation of the radar sensor 210.

In some examples, the radar sensor(s) 210 is a ground speed radar sensor configured to emit a radar beam towards a ground surface supporting the vehicle 100, in particular to the target X where the radar beam intersects ground surface. By analysing properties of the radio waves reflected from the target X, such as the shift in the frequency of the returned signal relative to the transmitted signal (the so-called Doppler shift), different motion parameters can be determined, as known in the art. For example, the radar sensor(s) 210 may be configured to obtain measurements relating to one or more of a longitudinal velocity vₓ of the vehicle 100, a lateral velocity v_{y} of the vehicle 100, a vertical velocity v_{z} of the vehicle 100, a yaw rate ω_{z} of the vehicle 100, a roll rate ωₓ of the vehicle 100, and a pitch rate ωy of the vehicle 100. This can be performed by processing circuitry, such as processing circuitry 230, communicatively coupled to the radar sensor(s) 210.

In the example of FIG. 2, the radar sensor 210 is mounted at a forward position of the vehicle 100. It may be envisaged that the radar sensor(s) 210 may be mounted elsewhere in the vehicle 100, for example in a wheel 110 (e.g. on a wheel rim, in part of the wheel hub, or in part of the tyre), as long as the radar sensor(s) 210 is capable of receiving reflected radio waves from the target X. Whilst a single radar sensor 210 is shown in FIG. 2, multiple radar sensors 210 may be present in the system 200. In this case, each radar sensor 210 may comprise a radar antenna communicatively coupled to common processing circuitry 230. In another example, each radar sensor 210 may have its own dedicated processing circuitry 230. In some examples, a combination of common and dedicated processing circuitry 230 may be provided. This disclosure is not limited to any particular radar sensor architecture, nor any particular processing circuitry architecture.

It is noted that a radar sensor 210 generally illuminates an area and not a localized small point, since the radar beam is normally not a true laser-like or pencil-shaped beam. Thus, even single-beam radar sensors simultaneously collect radar backscatter from different observation directions due to the spread of the main radar transmission lobe, i.e., due to the shape of the main lobe of the radar sensor antenna including effects of, e.g., the radar front end on the overall transmission pattern of the radar sensor. The radar sensor(s) 210 will therefore see a spectrum of different Doppler velocities corresponding to different viewing angles. The extent of the spread depends mainly on the antenna characteristics of the radar sensor(s) 210, but also the reflection properties of the environment and the vehicle components in the near-field of the radar sensor(s) 210. The radar beam may also penetrate slightly below the immediate surface of the ground.

Returning to FIG. 2, the one or more inertial sensors 220 may comprise any suitable inertial sensor known in the art. For example, the inertial sensor(s) 220 may comprise one or more accelerometers, gyroscopes, inertial measurement units, and the like. The inertial sensor(s) 220 are configured to determine various motion parameters of the vehicle 100, as known in the art. In particular, the inertial sensor(s) 220 may be configured to determine one or more of a yaw rate ω_{z} of the vehicle 100, a roll rate ωₓ of the vehicle 100, and a pitch rate ω_{y} of the vehicle 100. Assuming the vehicle 100 is a rigid body, the inertial sensor(s) 220 may be placed at any suitable position on the vehicle 100.

In some examples, a sensor (i.e. a radar sensor 210 and/or an inertial sensor 220) and processing circuitry 230 may be provided in a single, integrated unit. In these examples, the sensor(s) may be communicatively coupled to the processing circuitry 230 via any suitable circuit or wired network connection known in the art. In some examples, the sensor(s) and processing circuitry 230 may be provided in separate units. In these examples, the sensor(s) may be communicatively coupled to the processing circuitry 230 via any suitable wireless or network connection known in the art. In some examples, the processing circuitry 230 may be implemented by the processing circuitry 150 of the controller 140, or the processing circuitry 170 of the global controller 160 described in relation to FIG. 1. The sensor(s) may be communicatively coupled to the controller 140, and/or the global controller 160 in any suitable way, for example via a circuit or any other wired, wireless, or network connection known in the art. All communicative couplings may be implemented as a direct connection or via one or more intermediate entities.

Based on the structure and configuration of the motion estimation system 200, the various motion parameters can be related to each other. For example, the Doppler velocity vⱼ observed by a radar sensor 210 will be dependent on a combination of translational and rotational motion of the vehicle 100. The Doppler velocity vⱼ can be expressed as follows:

$${v}_{j} = - {v}_{x} {r}_{j}^{x} - {v}_{y} {r}_{j}^{y} + {ω}_{z} ( {c}_{j}^{y} {r}_{j}^{x} - {c}_{j}^{x} {r}_{j}^{y} ) \qquad ( 1 )$$

Accordingly, a linear relation between the Doppler velocity vⱼ and the state vector x can be expressed as follows:

$${v}_{j} = {C}_{j} x \qquad ( 2 )$$

where x≙[vₓ v_{y} ω_{z}]^{T} and

$${C}_{j} {=}^{Δ} [ - {r}_{j}^{x} - {r}_{j}^{y} ( {c}_{j}^{y} {r}_{j}^{x} - {c}_{j}^{x} {r}_{j}^{y} ) ] .$$

Cⱼ is a known row vector, which may be determined according to the mounting position and orientation of the radar sensor 210 on the vehicle 100.

Additionally, a measurement acquired by an inertial sensor 220 observing the yaw rate ω_{z} can be expressed as follows:

$${y}_{g} = [ 001 ] x \qquad ( 3 )$$

The available measurements can be concatenated into an augmented measurement vector y, which is related to the state vector by the following linear model:

$$y = C x \qquad ( 4 )$$

where the measurement vector is defined by y≙[y₁ . . . yₙ]^{T}, where

$${\{ {y}_{j} \}}_{j = 1}^{n}$$

indicates measurements from the j^{th} sensor, the total number of sensors (or sources of information) is n, and C is known as the measurement matrix. Here, the individual elements of the measurement vector include y values of one or more motion parameters of the vehicle (e.g, the Doppler velocity vⱼ from the radar sensor(s) 210 and the yaw rate ω₂ from the inertial sensor(s) 220). In some examples, the measurements correspond to the same time instant (i.e. they are obtained by the sensors 210, 220 simultaneously).

To obtain a unique and/or proper solution of the linear system given in equation (4), the matrix of each subset of the measurement matrix C must have full column rank. A subset of the measurement matrix C omits one of the received measurements (i.e. each subset includes n−1 measurements). If the matrix of each subset has full column rank, the measurement matrix C also has full column rank. This indicates that the system is overdetermined, i.e. there are a sufficient number of measurements and/or data sources to determine the unknown motion parameters, as will be understood by the skilled person. For all subsets formed by excluding one of the measurements, it is required that rank (C_{\j})=m, where C_{\j} is the measurement matrix of the subsets excluding the j^{th} measurement:

$${C}_{\backslash j} {=}^{Δ} [ \begin{matrix}⋮ \\ \\ ⋮\end{matrix} ] \} C \qquad ( 5 )$$

For such a system, an estimate \hat{x} of the state vector x can be computed as follows:

$$\hat{x} = {C}^{+} y , \qquad ( 6 )$$

where C⁺ is the pseudo inverse of the measurement matrix C, and is defined by:

$${C}^{+} = {( {C}^{T} C )}^{- 1} {C}^{T} . \qquad ( 7 )$$

In a special case, where the number of measurements is equal to the number of states, the measurement matrix C is a square matrix, which leads to C⁺=C⁻¹=\hat{x}=C⁻¹y.

As discussed above, in any real-world system, sensors can malfunction or be impeded from capturing accurate measurements. When the measurement vector y includes one or more outlier measurements, the corresponding estimate \hat{x} is typically corrupted by the erroneous information. It is therefore desired to provide an approach that can detect the existence of outliers in the measurement vector y, and further to identify which measurements are outliers in order to reject them from the provision of the estimate \hat{x}. This can be achieved by determine a discrepancy between the measurements and the computed estimate, as detailed below.

Assume a linear system defined as in equation (4), where x∈ [symbol] ^{m}, y∈ [symbol] ⁿ, C∈ [symbol] ^{n×m}. Using the pseudo inverse of the measurement matrix C defined in equation (7), the estimate \hat{x} can be determined using equation (6). This essentially minimizes the following cost function consisting of the sum of squared residuals:

$$J ( \hat{x} ) = ‖ y - C \hat{x} ‖$$

This is often referred to as a least squares estimation (LSE).

Accordingly, the discrepancy between the measurements in the measurement vector y and the estimate \hat{x} can be given by:

$${ϵ}_{y} = y - C \hat{x} \qquad ( 9 )$$

where ∈_{y} is called the measurement residual. The measurement residual ∈_{y} indicates the least squares error of the system and reveals the consistency of the measurements for the given system.

Based on this formulation, the presence of one or more outliers in the measurement vector y can be detected. In particular, a measurement can be obtained by each of the data sources (e.g. each of the one or more radar sensors 210 and each of the one or more inertial sensors 220). Given a number of unknown motion parameters m, n measurements are obtained. As discussed above, n is the total number of data sources (e.g. sensors 210, 220). The total number of data sources/sensors 210, 220 (and therefore the total number of measurements) is at least one more than the total number of unknown motion parameters, i.e. n>m. For example, the total number of unknown parameters m may be three or more, in which case the total number of sensors m is four or more. Consequently, it is possible to identify any inconsistency in the measurements.

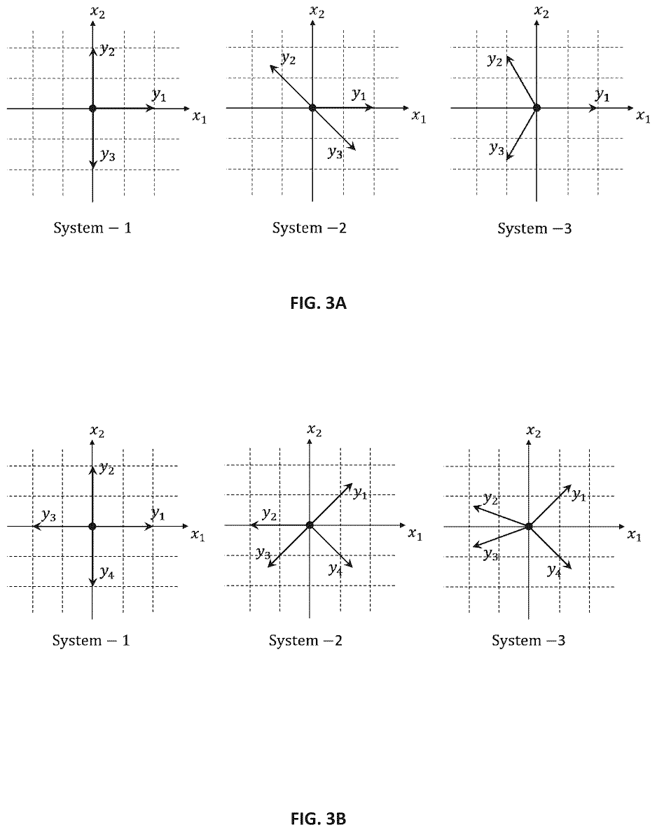

FIG. 3A geometrically illustrates three linear systems, which each comprise two state variables, x=[x₁ x₂]^{T} and three measurements, y=[y₁ y₂ y₃]^{T}. In System-1 and System-2, if y₁ is excluded from the measurement vector, the range space becomes 1-dimensional (equivalently, the rank of the corresponding sub-measurement matrix C is 1). Therefore, it cannot be determined whether y₁ is an outlier in these systems. System-3, however, complies with the aforementioned requirements, and it is therefore possible to detect the presence of an outlier regardless of which value it is.

In a system that complies with these requirements, an estimate \hat{x} of the unknown motion parameters can be determined, for example based on equations (6) and (7). In particular, using the pseudo inverse of the measurement matrix C, an estimation of each of the one or more unknown motion parameters can be obtained. The measurement residual ∈_{y} between the estimate \hat{x} and the received measurements y can then be determined based on equation (9). In the case that the estimate \hat{x} is a least squares estimation the unknown motion parameters, the residual represents a least squares error of the system.

Once the measurement residual ∈_{y} has been determined, the presence of one or more outliers in the measurements can be determined (or detected) by comparing the measurement residual ∈_{y} to an acceptance criterion, e.g. a threshold. If the measurement residual ∈_{y} is acceptable, the estimate \hat{x} can be provided as output and it can be stated that there is no outlier in the measurements. If the measurement residual ∈_{y} is not acceptable, further action can be taken, for example by discounting the estimate \hat{x}, notifying that maintenance of the sensors is required, and the like. In some examples, the identity of the outlier(s) can be determined, as will be discussed below.

The comparison of the measurement residual ∈_{y} to an acceptance criterion can be performed in any suitable manner. For example, the largest element and/or the norm of the measurement residual ∈_{y} can be compared to a threshold. In another example, outliers can be detected based on a statistical analysis of the measurement residual ∈_{y}. For example, accounting for known sensor noise characteristics, the measurement vector y can be expressed as follows:

$$y = C x + e , e ∼ N ( 0 , R ) \qquad ( 10 )$$

where, e represents the random sensor noise, which is Gaussian distributed with zero mean and covariance R. Then, the measurement residual ∈_{y} can be expressed as:

$$\begin{matrix}{ϵ}_{y} = y - C \hat{x} \\ = ( C x + e ) - C {C}^{+} ( C x + e ) \\ = C x + e - C x - C {C}^{+} e \\ = {\underbrace{( {I}_{n} - C {C}^{+} )}}_{{=}^{Δ} Δ} e\end{matrix} \qquad ( 11 )$$

where Iₙ is an n×n identity matrix. Equation (11) implies the following distribution for the measurement residual ∈_{y}:

$${ϵ}_{y} ∼ N ( 0 , Δ R {Δ}^{T} ) . \qquad ( 12 )$$

From this, the statistic T can be determined as follows:

$$T ( y ) {=}^{Δ} {ϵ}_{y}^{T} {( Δ R {Δ}^{T} )}^{- 1} {ϵ}_{y} ∼ {{χ}^{2}}^{} ( n ) , \qquad ( 13 )$$

which has a chi-square distribution with n degrees of freedom. The existence of outliers can be determined by considering this as a threshold such that:

$$T ( y ) > {χ}_{α}^{2} ( n ) \qquad ( 14 )$$

This method is commonly referred to as hypothesis/chi-squared testing or gating.

This approach will now be exemplified in terms of a number of examples. In the following examples, there are two state variables, i.e., x≙[x₁ x₂]^{T}, where the true value of the state vector is arbitrarily selected to be xₜᵣᵤₑ ≙[1 1]^{T}.

### Example-1

To be able to compute the pseudo inverse of the measurement matrix C, at least two measurements are required. The most straightforward realization of such a system is given by:

$$y {=}^{Δ} [ \begin{matrix}1 & 0 \\ 0 & 1\end{matrix} ] x$$

| y | \hat{x} | ∈_{y} | Observation |
|---|---|---|---|
| [1 1]^{T} | [1 1]^{T} | [0 0]^{T} | All measurements are inliers. |
| [1 10]^{T} | [1 10]^{T} | [0 0]^{T} | There is an outlier, hence the estimate is |
| | | | corrupted. However, detecting the existence |
| | | | of the outlier is not possible, as the |
| | | | measurement residual does not indicate any |
| | | | inconsistency. |

Note that in this example, the total number of measurements is the same the total number of unknown motion parameters, i.e. n=m, and so the presence of the outlier cannot be detected.

### Example-2

In this example, one more measurement is incorporated into the system:

$$y {=}^{Δ} [ \begin{matrix}1 & 0 \\ 0 & 1 \\ 1 & 0\end{matrix} ] x$$

| y | \hat{x} | ∈_{y} | Observation |
|---|---|---|---|
| [1 1 1]^{T} | [1 1]^{T} | [0 0 0]^{T} | All measurements are inliers. |
| [10 1 1]^{T} | [5.5 1]^{T} | [4.5 0 −4.5]^{T} | The existence of the outlier |
| [1 1 10]^{T} | [5.5 1]^{T} | [−4.5 0 4.5]^{T} | can be detected. |
| [1 10 1] | [1 10]^{T} | [0 0 0]^{T} | There is an outlier, hence the |
| | | | estimate is corrupted. However, |
| | | | detecting the existence of the |
| | | | outlier is not possible, as the |
| | | | measurement residual does not |
| | | | indicate any inconsistency. |

In this example, the total number of measurements is greater than the total number of unknown motion parameters, i.e. n>m, and so the presence of the outlier can be detected in some cases.

### Example-3

It is also possible to define an efficient and/or cost-effective system, using only three sensors, which is still capable of detecting any outlier:

$$y {=}^{Δ} [ \begin{matrix}1 & 0 \\ 0 & 1 \\ 1 & 1\end{matrix} ] x$$

| y | \hat{x} | ∈_{y} | Observation |
|---|---|---|---|
| [1 1 2]^{T} | [1 1]^{T} | [0 0 0]^{T} | All measurements are inliers. |
| [10 1 2]^{T} | [7 −2]^{T} | [3 3 −3]^{T} | In all cases, the existence of |
| [1 10 2]^{T} | [−2 7]^{T} | [3 3 −3]^{T} | the outlier can be detected. |
| [1 1 10]^{T} | [3.7 3.7]^{T} | [−2.7 −2.7 2.6]^{T} | |

In an extension of the approach outlined above, it is possible to identify not only the presence of an outlier, but also which one of the measurements is the outlier. Thereafter, a reliable estimate \hat{x} can be determined by excluding the outlier measurement from the measurement vector y.

To achieve this, the total number of data sources (e.g. sensors 210, 220), and therefore the total number of measurements, is at least two more than the total number of unknown motion parameters, i.e. n>m+1. For example, the total number of unknown motion parameters m may be three or more, in which case the total number of sensors m is five or more. Any suitable combination of radar sensors 210 and inertial sensors 220 can be used to provide the sufficient number of measurements. It will be noted that, as the minimum number of unknown motion parameters is one, the minimum total number of data sources is three.

In this approach, a measurement can be obtained by each of the (three or more) sensors 210, 220. A plurality of subsets of the measurements is then determined, where each subset omits one of the received measurements (i.e. each subset includes n−1 measurements). The number of subsets correspond to the number of measurements n (i.e. there is a subset omitting each one of the measurements n). Each subset is required to be able to identify the existence of any outlier, i.e, for each subset, the number of measurements must be at least one more than the total number of unknown motion parameters, and each further subset (where each further subset omits one of the received measurements from an initial subset) must have full column rank.

For each subset excluding the j^{th} measurement, a corresponding estimate \hat{x}^{j} of the unknown motion parameters can be determined, for example in the manner discussed above. A corresponding measurement residual ∈_{y}ⁱ between the estimate \hat{x}^{j} and the subset of measurements is then determined, for example based on equation (9). This results in a plurality of measurement residuals ∈_{y}^{j}, one for each subset of the measurements. Based on the determined measurement residuals ∈_{y}^{j}, the identity of any outlier(s) in the system can be determined. For example, it can be assumed that the subset that produces the most insignificant measurement residual ∈_{y}^{j} should be that formed by excluding the outlier measurement. The corresponding estimate \hat{x}^{j} can be considered more reliable than the initial estimate \hat{x}, having identified and excluded the outlier measurement.

FIG. 3B geometrically illustrates three linear systems, which each comprise two state variables, x=[x₁ x₂]^{T} and four measurements, y=[y₁ y₂ y₃ y₄]^{T}. Due to having linearly dependent pairs of observations in System-1 (y₁, y₃ and y₂, y₄) and System-2 (y₁, y₃), it is not possible to identify and reject any outlier measurement. However, satisfying the given requirements, System-3 is able to identify an outlier in all cases.

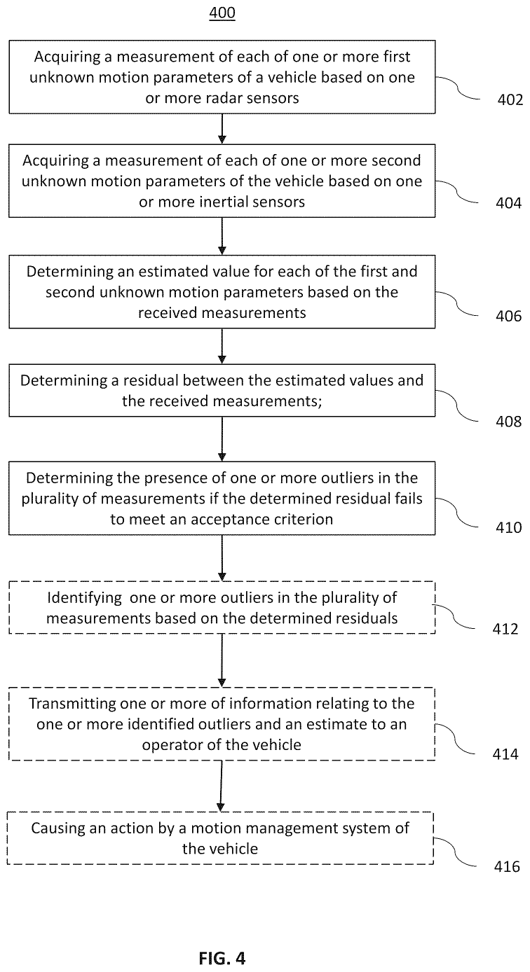

FIG. 4 is a flow chart of a computer-implemented method 400 according to an example. The method 400 is for determining (or detecting) the presence of one or more outliers in a plurality of measurements made by a motion estimation system of a vehicle. The method 400 enables outliers to be detected and identified in order to provide more accurate estimations of vehicle motion. The method 400 may be implemented by processing circuitry of a computer system (e.g., the processing circuitry 150 of the controller(s) 140, the processing circuitry 170 of the global controller 160 described in relation to FIG. 1, or the processing circuitry 230 of the motion estimation system 200 described in relation to FIG. 2).

At 402, a measurement is acquired relating to one or more first unknown motion parameters of a vehicle 100 from each of one or more radar sensors 210. As discussed above, the radar sensor(s) 210 may be configured to obtain measurements relating to one or more of a Doppler velocity vⱼ, a longitudinal velocity vₓ of the vehicle 100, a lateral velocity v_{y} of the vehicle 100, a vertical velocity v_{z} of the vehicle 100, a yaw rate ω_{z} of the vehicle 100, a roll rate ωₓ of the vehicle 100, and a pitch rate ω_{y} of the vehicle 100. In some examples, a first motion parameter may be determined by processing circuitry local to the radar sensor(s) 210 and provided to the processing circuitry 150, 170, 230. In some embodiments, the radar sensor(s) 210 may detect a Doppler velocity vⱼ, which is further processed by the processing circuitry 150, 170, 230 to determine values for one or more first motion parameters.

At 404, a measurement is acquired relating to one or more second unknown motion parameters of the vehicle 100 from each of one or more inertial sensors 220. As discussed above, the inertial sensor(s) 220 may be configured to obtain measurements relating to one or more of a yaw rate ω_{z} of the vehicle 100, a roll rate ωₓ of the vehicle 100, and a pitch rate ω_{y} of the vehicle 100. In some examples, a second motion parameter may be determined by processing circuitry local to the inertial sensor(s) 220 and provided to the processing circuitry 150, 170, 230.

As discussed above, total number of data sources/sensors 210, 220 (and therefore the total number of measurements) is at least one more than the total number of unknown motion parameters, i.e. n>m. For example, the total number of unknown parameters m may be three or more, in which case the total number of sensors m is four or more. Consequently, it is possible to identify any inconsistency in the measurements.

At 406, an estimated value for each of the first and second unknown motion parameters is determined based on the received measurements. For example, an estimate \hat{x} of the unknown motion parameters can be determined based on equations (6) and (7), or in any other suitable manner known in the art. In particular, using the pseudo inverse of the measurement matrix C, an estimation of each of the one or more unknown motion parameters can be obtained.

At 408, a residual between the estimated values and the received measurements is determined. For example, the measurement residual ∈_{y} between the estimate \hat{x} and the received measurements y can be determined based on equation (9), or in any other suitable manner known in the art. In the case that the estimate \hat{x} is a least squares estimation the unknown motion parameters, the residual represents a least squares error of the system.

At 410, the presence of one or more outliers in the plurality of measurements is determined (or detected). For example, the presence of one or more outliers in the plurality of measurements is determined if the determined residual fails to meet an acceptance criterion, e.g. falling above (or below) a threshold. The comparison of the measurement residual ∈_{y} to an acceptance criterion can be performed in any suitable manner. For example, the largest element and/or the norm of the measurement residual ∈_{y} can be compared to a threshold and, if it exceeds (or not) the threshold, an outlier is detected. In another example, outliers can be detected based on a statistical analysis of the measurement residual ∈_{y}. If the measurement residual ∈_{y} meet an acceptance criterion, the estimate \hat{x} can be provided as output and it can be stated that there is no outlier in the measurements. If the measurement residual ∈_{y} is not acceptable, further action can be taken, for example by discounting the estimate \hat{x}, notifying that maintenance of the sensors is required, and the like.

In some examples, at 412, one or more outliers in the plurality of measurements are identified, i.e. a specific measurement that is considered to be an outlier can be identified, rather than just determining that it is present somewhere in the system. For example and as discussed above, measurements may be received from each of three or more data sources. Here, the total number of data sources is at least two more than the total number of unknown motion parameters. A plurality of subsets of the received measurements, wherein each subset omits one of the received measurements, and an estimate \hat{x} of the unknown motion parameters in each subset, are determined. A corresponding measurement residual ∈_{y}^{j} between the estimate \hat{x}^{j} and the subset of measurements is then determined, and identity of any outlier(s) in the system can be determined based on the determined residuals ∈_{y}^{j}.

In some examples, at 414, information relating to the one or more identified outliers, for example its existence, identity, the erroneous value, and/or an indication that maintenance of a sensor is required can be transmitted to an operator of the vehicle 100. Similarly, an estimate of motion of the vehicle 100 can be transmitted to the operator. If the initial measurement residual ∈_{y} is acceptable, the initial estimate \hat{x} can be transmitted and it can be stated that there is no outlier in the measurement. If an outlier is identified, the subset having the best measurement residual ∈_{y}^{j} can be transmitted. For example, the information relating to the one or more identified outliers and/or an estimate of vehicle motion can be provided via a user interface for an operator of the vehicle 100.

In some examples, at 416, an action by a motion management system of the vehicle can be caused in response to determining the presence of one or more outliers. For example, the initial estimate \hat{x} can be discounted, and vehicle motion can be estimated based on other inputs, or it may be determined that vehicle control is not possible based on the initial estimate x, and a driver input is required.

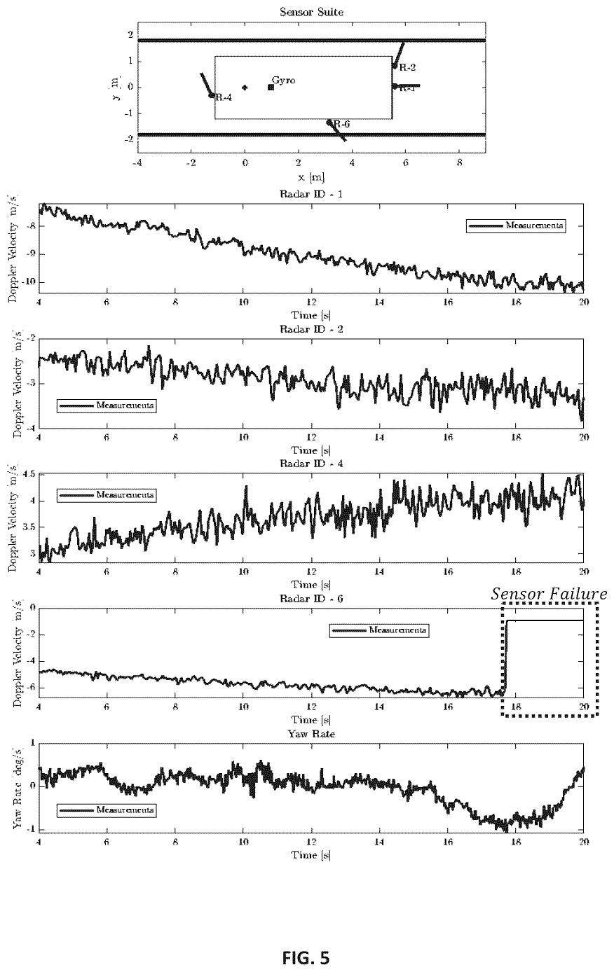

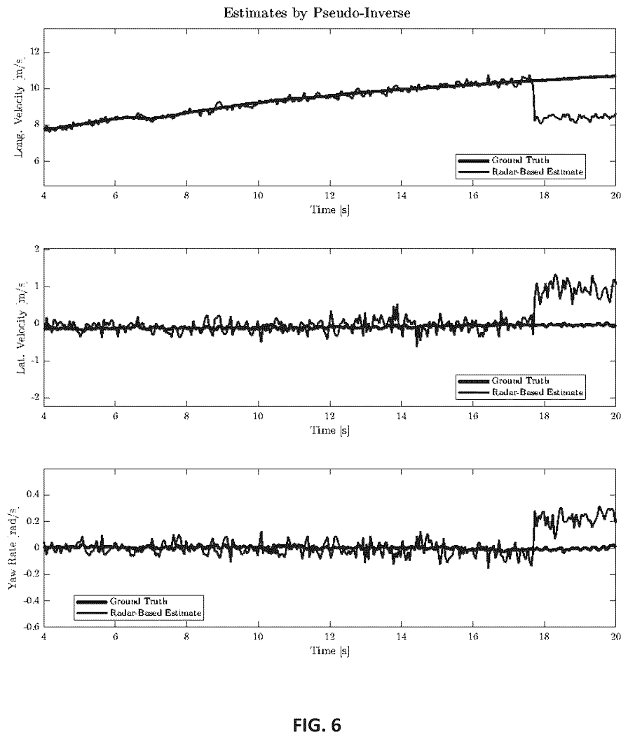

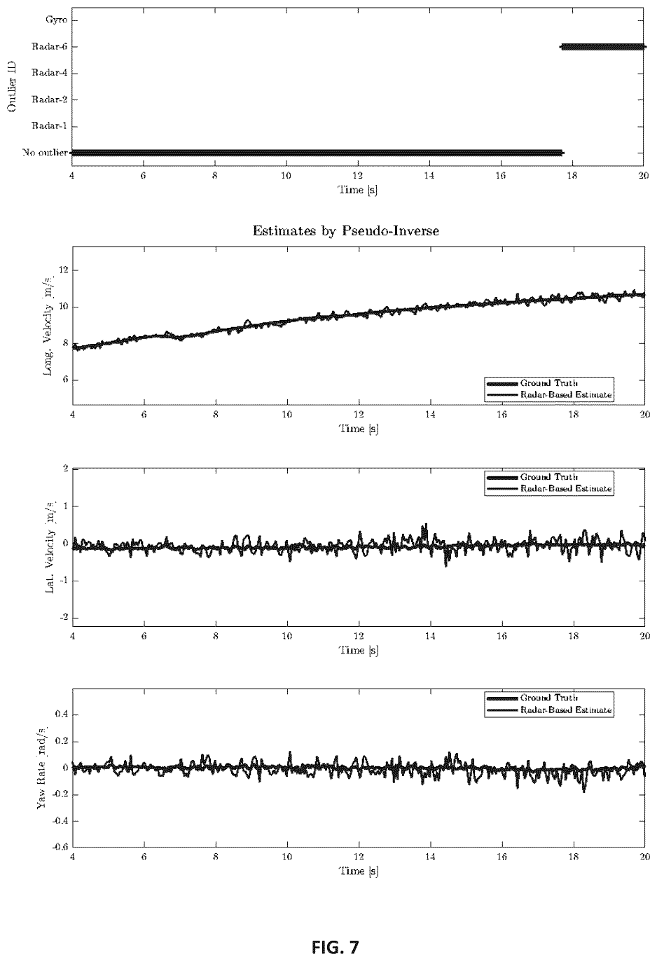

FIG. 5 illustrates the results of testing of a vehicle motion estimation system comprising four radar sensors measuring Doppler velocity and a gyroscope observing yaw rate. In the testing, the ego vehicle moves along a straight line while there is a snowplough operating nearby. Most likely due to the dense layer of snow particles in the air, Radar-6 generates erroneous measurements towards the end of testing period. The motion estimates obtained by a standard LSE algorithm by processing all available measurements without any outlier identification/rejection mechanism are shown in FIG. 6. As can be clearly seen, after Radar-6 starts reporting outlier measurements, the accuracy of the estimates degrades. FIG. 7 illustrates the motion estimates obtained by excluding the identified outliers as proposed in this disclosure. As can be clearly seen, the disclosed approach can satisfactorily identify the outlier measurement and maintain proper estimates without any loss in performance.

In some examples, additional approaches to determining the presence of an outlier may be used. For example, outliers from the radar sensor(s) 210 may be detected by comparing an actual range-Doppler appearance to an expected range-Doppler appearance of the output of each radar sensor 210 given the estimated motion. Ground speed radars, for example, are expected to generate a particular pattern in range-Doppler velocity maps due to the characteristics of the sensor-road geometry, as known in the art. Therefore, at each measurement scan, it is possible to analyse if this pattern is not clearly available or significantly corrupted. If such a condition is identified, the sensor can potentially defer generating a Doppler velocity measurement or inform the end-user that the corresponding measurement is not reliable. This approach essentially leads to a setup in which each sensor assures the integrity of its outputs. Further operations can optionally be conducted to assess the consistency of different sensor outputs. In some examples, the output from the inertial sensor(s) 220 may be trusted and any discrepancy between the output of the inertial sensor(s) 220 and a corresponding estimation from the radar sensor(s) 210 can be used to detect outliers in the radar sensor(s) 210.

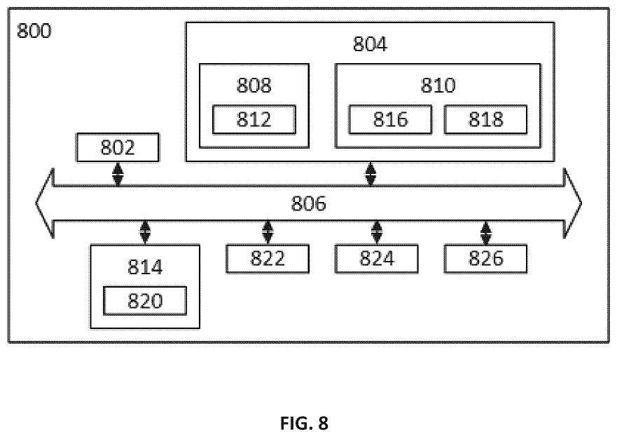

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein.

The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A system (200) comprising: one or more radar sensors (210) configured to obtain measurements relating to one or more first unknown motion parameters of a vehicle (100); one or more inertial sensors (220) configured to obtain measurements relating to one or more second unknown motion parameters of the vehicle (100), wherein the total number of sensors (210, 220) is at least one more than the total number of unknown motion parameters; and processing circuitry (150, 170, 230) configured to: acquire a measurement of each of the first unknown motion parameters from the one or more radar sensors (210); acquire a measurement of each of the second unknown motion parameters from the one or more inertial sensors (220); determine an estimated value for each of the first and second unknown motion parameters based on the received measurements; determine a residual between the estimated values and the received measurements; and determine the presence of one or more outliers in the plurality of measurements if the determined residual fails to meet an acceptance criterion.

Example 2: The system (200) of example 1, wherein the one or more radar sensors (210) comprise one or more ground speed radar sensors.

Example 3: The system (200) of example 1 or 2, wherein the one or more inertial sensors (220) comprise one or more of an accelerometer and a gyroscope.

Example 4: The system (200) of any preceding example, wherein the first unknown motion parameters comprise one or more of a longitudinal velocity of the vehicle (100), a lateral velocity of the vehicle (100), a vertical velocity of the vehicle (100), a yaw rate of the vehicle (100), a roll rate of the vehicle (100), and a pitch rate of the vehicle (100).

Example 5: The system (200) of any preceding example, wherein the second unknown motion parameters comprise one or more of a yaw rate of the vehicle (100), a roll rate of the vehicle (100), and a pitch rate of the vehicle (100).

Example 6: The system (200) of any preceding example, wherein the total number of unknown parameters is three or more.

Example 7: The system (200) of any preceding example, wherein the processing circuitry (150, 170, 230) is configured to acquire a measurement from each of the sensors (210, 220).

Example 8: The system (200) of any preceding example, wherein the received measurements are obtained by the sensors (210, 220) at a same time instant.

Example 9: The system (200) of any preceding example, wherein the processing circuitry (150, 170, 230) is configured to determine an estimated value for each of the one or more unknown motion parameters using a pseudo inverse of a measurement matrix.

Example 10: The system (200) of any preceding example, wherein the processing circuitry (150, 170, 230) is configured to determine a least squares estimation of each of the one or more unknown motion parameters, and wherein the residual represents a least squares error.

Example 11: The system (200) of any preceding example, wherein each subset of a measurement matrix has full column rank, wherein each subset omits one of the received measurements.

Example 12: The system (200) of any preceding example, comprising three or more sensors (210, 220), wherein the processing circuitry (150, 170, 230) is configured to: receive a measurement from each of the three or more sensors (210, 220), wherein the total number of sensors is at least two more than the total number of unknown motion parameters; determine a plurality of subsets of the received measurements, wherein each subset omits one of the received measurements; determine an estimated value for each of the first and second unknown motion parameters for each determined subset of the received measurements; determine a residual between the respective estimated values and each determined subset of the received measurements; and identify one or more outliers in the plurality of measurements based on the determined residuals.

Example 13: The system (200) of any preceding example, wherein the processing circuitry (150, 170, 230) is further configured to provide one or more of information relating to the one or more identified outliers and an estimate of vehicle motion via a user interface for an operator of the vehicle (100).

Example 14: The system (200) of any preceding example, wherein the processing circuitry (150, 170, 230) is further configured to cause an action by a motion management system (140, 160) of the vehicle (100) in response to determining the presence of one or more outliers.

Example 15: A vehicle (100) comprising the system (200) of any preceding example.

Example 16: A computer-implemented method (400) comprising: acquiring (402), by processing circuitry (150, 170, 230) of a computer system (140, 160, 200), a measurement of each of one or more first unknown motion parameters of a vehicle (100) based on one or more radar sensors (210); acquiring (404), by the processing circuitry (150, 170, 230), a measurement of each of one or more second unknown motion parameters of the vehicle (100) based on one or more inertial sensors (220), wherein the total number of sensors (210, 220) is at least one more than the total number of unknown motion parameters; determining (406), by the processing circuitry (150, 170, 230), an estimated value for each of the first and second unknown motion parameters based on the received measurements; determining (408), by the processing circuitry (150, 170, 230), a residual between the estimated values and the received measurements; and determining (410), by the processing circuitry (150, 170, 230), the presence of one or more outliers in the plurality of measurements if the determined residual fails to meet an acceptance criterion.

Example 17: The computer-implemented method (400) of example 16, wherein the one or more radar sensors (210) comprise one or more ground speed radar sensors.

Example 18: The computer-implemented method (400) of example 16 or 17, wherein the one or more inertial sensors (220) comprise one or more of an accelerometer and a gyroscope.

Example 19: The computer-implemented method (400) of any of examples 16 to 18, wherein the first unknown motion parameters comprise one or more of a longitudinal velocity of the vehicle (100), a lateral velocity of the vehicle (100), a vertical velocity of the vehicle (100), a yaw rate of the vehicle (100), a roll rate of the vehicle (100), and a pitch rate of the vehicle (100).

Example 20: The computer-implemented method (400) of any of examples 16 to 19, wherein the second unknown motion parameters comprise one or more of a yaw rate of the vehicle (100), a roll rate of the vehicle (100), and a pitch rate of the vehicle (100).

Example 21: The computer-implemented method (400) of any of examples 16 to 20, wherein the total number of unknown parameters is three or more.

Example 22: The computer-implemented method (400) of any of examples 16 to 21, comprising acquiring, by the processing circuitry (150, 170, 230), a measurement from each of the sensors (210, 220).

Example 23: The computer-implemented method (400) of any of examples 16 to 22, wherein the received measurements are obtained by the sensors (210, 220) at a same time instant.

Example 24: The computer-implemented method (400) of any of examples 16 to 23, comprising determining, by the processing circuitry (150, 170, 230), an estimated value for each of the one or more unknown motion parameters using a pseudo inverse of a measurement matrix.

Example 25: The computer-implemented method (400) of any of examples 16 to 24, comprising determining, by the processing circuitry (150, 170, 230), a least squares estimation of each of the one or more unknown motion parameters, wherein the residual represents a least squares error.

Example 26: The computer-implemented method (400) of any of examples 16 to 25, wherein each subset of a measurement matrix has full column rank, wherein each subset omits one of the received measurements.

Example 27: The computer-implemented method (400) of any of examples 16 to 26, further comprising: acquiring, by the processing circuitry (150, 170, 230), a measurement from each of three or more sensors (210, 220), wherein the total number of sensors is at least two more than the total number of unknown motion parameters; determining, by the processing circuitry (150, 170, 230), a plurality of subsets of the received measurements, wherein each subset omits one of the received measurements; determining, by the processing circuitry (150, 170, 230), an estimated value for each of the first and second unknown motion parameters for each determined subset of the received measurements; determining, by the processing circuitry (150, 170, 230), a residual between the respective estimated values and each determined subset of the received measurements; and identifying (412), by the processing circuitry (150, 170, 230), one or more outliers in the plurality of measurements based on the determined residuals.

Example 28: The computer-implemented method (400) of any of examples 16 to 27, further comprising providing (414), by the processing circuitry (150, 170, 230), one or more of information relating to the one or more identified outliers and an estimate of vehicle motion via a user interface for an operator of the vehicle (100).

Example 29: The computer-implemented method (400) of any of examples 16 to 28, further comprising causing (416), by the processing circuitry (150, 170, 230), an action by a motion management system (140, 160) of the vehicle (100) in response to determining the presence of one or more outliers.

Example 30: A computer program product comprising program code for performing, when executed by processing circuitry (150, 170, 230), the computer-implemented method (400) of any of examples 16 to 29.

Example 31: A non-transitory computer-readable storage medium comprising instructions, which when executed by processing circuitry (150, 170, 230), cause the processing circuitry (150, 170, 230) to perform the computer-implemented method (400) of any of examples 16 to 29.

Example 31: A computer system (140, 160, 200) comprising processing circuitry (150, 170, 230) configured to perform the computer-implemented method (400) of any of examples 16 to 29.

Terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A system comprising:
one or more radar sensors configured to obtain measurements relating to one or more first unknown motion parameters of a vehicle;
one or more inertial sensors configured to obtain measurements relating to one or more second unknown motion parameters of the vehicle, wherein the total number of sensors is at least one more than the total number of unknown motion parameters; and
processing circuitry configured to:
acquire a measurement of each of the first unknown motion parameters from the one or more radar sensors;
acquire a measurement of each of the second unknown motion parameters from the one or more inertial sensors;
determine an estimated value for each of the first and second unknown motion parameters based on the received measurements;
determine a residual between the estimated values and the received measurements; and
determine the presence of one or more outliers in the plurality of measurements if the determined residual fails to meet an acceptance criterion.

2. The system of claim 1, wherein the one or more radar sensors comprise one or more ground speed radar sensors.

3. The system of claim 1, wherein the one or more inertial sensors comprise one or more of an accelerometer and a gyroscope.

4. The system of claim 1, wherein the first unknown motion parameters comprise one or more of a longitudinal velocity of the vehicle, a lateral velocity of the vehicle, a vertical velocity of the vehicle, a yaw rate of the vehicle, a roll rate of the vehicle, and a pitch rate of the vehicle.

5. The system of claim 1, wherein the second unknown motion parameters comprise one or more of a yaw rate of the vehicle, a roll rate of the vehicle, and a pitch rate of the vehicle.

6. The system of claim 1, wherein the total number of unknown parameters is three or more.

7. The system of claim 1, wherein the processing circuitry is configured to acquire a measurement from each of the sensors.

8. The system of claim 1, wherein the received measurements are obtained by the sensors at a same time instant.

9. The system of claim 1, wherein the processing circuitry is configured to determine the estimated value for each of the one or more unknown motion parameters using a pseudo inverse of a measurement matrix.

10. The system of claim 1, wherein the processing circuitry is configured to determine a least squares estimation of each of the one or more unknown motion parameters, and wherein the residual represents a least squares error.

11. The system of claim 1, wherein each subset of a measurement matrix, which omits one of the received measurements, has full column rank.

12. The system of claim 1, comprising three or more sensors, wherein the processing circuitry is configured to:
receive a measurement from each of the three or more sensors, wherein the total number of sensors is at least two more than the total number of unknown motion parameters;
determine a plurality of subsets of the received measurements, wherein each subset omits one of the received measurements;
determine an estimated value for each of the first and second unknown motion parameters for each determined subset of the received measurements;
determine a residual between the respective estimated values and each determined subset of the received measurements; and
identify one or more outliers in the plurality of measurements based on the determined residuals.

13. The system of claim 1, wherein the processing circuitry is further configured to provide one or more of information relating to the one or more identified outliers and an estimate of vehicle motion via a user interface for an operator of the vehicle.

14. The system of claim 1, wherein the processing circuitry is further configured to cause an action by a motion management system of the vehicle in response to determining the presence of one or more outliers.

15. A vehicle comprising the system of claim 1.

16. A computer-implemented method comprising:
acquiring, by processing circuitry of a computer system, a measurement of each of one or more first unknown motion parameters of a vehicle based on one or more radar sensors;
acquiring, by the processing circuitry, a measurement of each of one or more second unknown motion parameters of the vehicle based on one or more inertial sensors, wherein the total number of sensors is at least one more than the total number of unknown motion parameters;
determining, by the processing circuitry, an estimated value for each of the first and second unknown motion parameters based on the received measurements;
determining, by the processing circuitry, a residual between the estimated values and the received measurements; and
determining, by the processing circuitry, the presence of one or more outliers in the plurality of measurements if the determined residual fails to meet an acceptance criterion.

17. A computer program product comprising program code for performing, when executed by processing circuitry, the computer-implemented method of claim 16.

18. A non-transitory computer-readable storage medium comprising instructions, which when executed by processing circuitry, cause the processing circuitry to perform the computer-implemented method of claim 16.
